(19) United States
(12) Patent Application Publication
(10) Pub. No.: US 2026/0114469 A1
(43) Pub. Date: Apr. 30, 2026

(54) Vertical Smoothie Maker

(71) Applicant: Cixi City Spring Electric Appliance Co.,Ltd., Cixi City (CN)

(72) Inventor: Hongya YU, Cixi City (CN)

(73) Assignee: Cixi City Spring Electric Appliance Co.,Ltd., Cixi City (CN)

(21) Appl. No.: 19/432,803

(22) Filed: Dec. 24, 2025

(30) Foreign Application Priority Data
Nov. 6, 2025 (CN) 202522356473.1

(51) Int. Cl. A23G 9/04; A23G 9/12; A23G 9/28; A23G 9/30

(52) U.S. Cl. CPC A23G 9/045; A23G 9/12; A23G 9/283; A23G 9/30

(57) ABSTRACT

Disclosed is a vertical slush machine, comprising a main body, which houses a refrigeration device, a dispensing base formed at the front of the main body, an ice-making cylinder, vertically installed within the dispensing base, a scraper, fitted around the outside of the ice-making cylinder and driven by a driving component to rotate around axis L relative to the ice-making cylinder, and an ice cup, which is mounted on the dispensing base, completely covering the ice-making cylinder, and forming a beverage production chamber in combination with the dispensing base. Compared with the prior art, the advantageous characteristic of the disclosed device is: the core components such as the ice-making cylinder and scraper are vertically installed, which significantly reduces the footprint of the equipment on the tabletop compared to traditional horizontal evaporator structures, making it more suitable for small spaces, and requiring no extra horizontal space for storage.

### TECHNICAL FIELD

The present utility model relates to ice making equipment, and more particularly to a vertical ice shaver.

### BACKGROUND

A smoothie machine, also known as a slush machine, a granita machine, or a frozen juice machine, is what we commonly call a freezing machine. It is used to process frozen desserts such as smoothies and slushies. This beverage is suitable for all ages and is an excellent choice for cooling down in the hot summer.

Slush machines in the prior art typically employ a horizontal evaporator structure. A spiral scraper is arranged outside the evaporator structure to scrape off the slush that condenses on the outer wall of the evaporator and guide it to the discharge port through the spiral structure.

However, horizontally arranged slush machines occupy a large amount of table space and are inconvenient to store. Furthermore, the spiral scraper cannot guide the slush that falls to the bottom of the beverage container, resulting in slush residue.

Chinese invention patent with publication number CN120585209A discloses a beverage machine, including a storage barrel, a refrigeration device, a discharge support, a discharge control mechanism, and a thermal insulation component; the storage barrel is used to contain liquid, and there is at least one; the refrigeration device includes an evaporation tube, used to refrigerate the liquid in the storage barrel; the discharge support is arranged at the discharge end of the storage barrel and is provided with a thermal insulation cavity and a material passage; the discharge control mechanism is arranged at the bottom of the material passage and is used to control the liquid discharge amount of the storage barrel; the thermal insulation component is arranged in the thermal insulation cavity and is used to insulate the discharge support. In the beverage machine of this application, the discharge support can achieve thermal insulation through the thermal insulation component. Even if the discharge support contacts the liquid in the storage barrel and cools down, the probability of condensation water forming on the discharge support is reduced under the action of the thermal insulation component, thereby improving aesthetics and hygiene. At the same time, a discharge control mechanism is arranged at the bottom of the discharge end of the material passage of the discharge support, which is convenient for users to install and maintain the discharge control mechanism.

The storage barrel and the thermal insulation component of the beverage machine are arranged vertically, and the discharge control mechanism is located at the bottom of the filter passage; that is, the material is discharged from the bottom of the storage barrel. With this arrangement, it is necessary to ensure the sealing performance of the storage barrel when installed on the main unit to avoid gaps that cause the melted ice water of the slush to seep out. At the same time, it is necessary to ensure that the main unit can be started only after the storage barrel is installed in place to ensure safety during the ice-making process.

Furthermore, during the process of making low-temperature beverages, the slush machine will cool the storage barrel outside the refrigeration device, causing the air inside and outside the storage barrel to liquefy on the inner and outer walls of the storage barrel, forming condensation water. The condensation water flows down along the barrel wall of the storage barrel and accumulates on the main unit, causing the main unit to become damp. Moreover, a large amount of condensation water seeps into the interior of the main unit, affecting the normal use of other components inside the main unit.

### SUMMARY

In order to solve the above-mentioned problems existing in the prior art, the present utility model provides a vertical ice shaver.

The above-mentioned problem of the present utility model is solved by the following technical solutions:
In an embodiment of the above technical solution, the ice cup and the discharge seat are locked and connected, and an activation device is provided to control the energization of the circuit system in the host machine;
In an embodiment of the above technical solution, the upper end of the activation component extends above the discharge seat and is located on the installation path of the ice cup; the lower end of the activation component corresponds to the activation button of the micro switch.

In an embodiment of the above technical solution, a plurality of guide blocks extend from the outer periphery of the bottom of the ice cup, and a guide groove capable of receiving the guide blocks sliding in is provided on the inner wall of the discharge seat.

In an embodiment of the above technical solution, the discharge seat includes a discharge base and a discharge cover, the upper end surface of the discharge base forms an ice receiving surface for receiving shaved ice, and the discharge cover has a surrounding wall for boundary limitation of the ice receiving surface;

In an embodiment of the above technical solution, the discharge seat is provided with an external drainage structure and an internal drainage structure, the external drainage structure is located inside the discharge seat, and drains the condensed water liquefied on the outer wall of the ice cup; the internal drainage structure is located inside the host machine, and drains the condensed water liquefied at the bottom of the discharge seat;

In an embodiment of the above technical solution, the internal drainage structure includes a water receiving seat arranged below the discharge seat and located inside the host machine, for receiving condensed water dripping from the bottom of the discharge seat;

In an embodiment of the above technical solution, the scraper includes an ice scraping strip extending along the axial direction of the ice making cylinder, the lower end of the ice scraping strip is provided with an ice shovel, and the ice shovel and the ice receiving surface of the ice shaver are arranged at an acute angle.

In an embodiment of the above technical solution, a reinforcing rib extending along the axial direction thereof is arranged on the inner wall of the ice cup for scraping off the ice layer covering the reinforcing rib, and the width of the reinforcing rib is gradually reduced along the ice outlet direction of the ice making cylinder, so that the outer surface of the reinforcing rib gradually moves away from the central axis of the ice making cylinder.

In an embodiment of the above technical solution, the ice making cylinder includes an inner cylinder and an outer cylinder sleeved outside the inner cylinder, and a refrigeration cavity is formed between the inner cylinder and the outer cylinder;

Compared with the prior art, the beneficial effects of the present utility model are that: the core components such as the ice making cylinder and the scraper are installed vertically, which significantly reduces the floor space of the equipment on the desktop compared with the traditional horizontal evaporator structure, making it more suitable for small space usage scenarios, and there is no need to reserve extra horizontal space during storage.

### BRIEF DESCRIPTION OF THE DRAWINGS

FIG. 1 is an exploded view of the structure of this utility model.

FIG. 2 is an exploded view of the dispensing base and the ice cup.

FIG. 3 is an exploded view of the activation device and the dispensing base.

FIG. 4 is an enlarged view of part A in FIG. 1.

FIG. 5 is an exploded view of the dispensing base and the dispenser.

FIG. 6 is a schematic diagram of the ice receiving surface.

FIG. 7 is a cross-sectional view of the dispensing tube.

FIG. 8 is a schematic diagram of the dispensing base.

FIG. 9 is an exploded view of the drainage structure.

FIG. 10 is a cross-sectional view of the first drain outlet.

FIG. 11 is a schematic diagram of the scraper.

FIG. 12 is an enlarged view of the ice scraping edge.

FIG. 13 is a schematic diagram of another scraper structure.

FIG. 14 is an exploded view of the ice cup and lid.

FIG. 15 is a schematic diagram of the internal structure of the ice cup.

FIG. 16 is a cross-sectional view of the ice-making cylinder.

FIG. 17 is a schematic diagram of the dispenser.

### DETAILED DESCRIPTION OF EMBODIMENTS

To further elaborate on the technical means and effects adopted by the present utility model to achieve the intended utility model purpose, the following detailed description will be made with reference to the accompanying drawings and preferred embodiments, based on the structure, features, and effects of the present utility model.

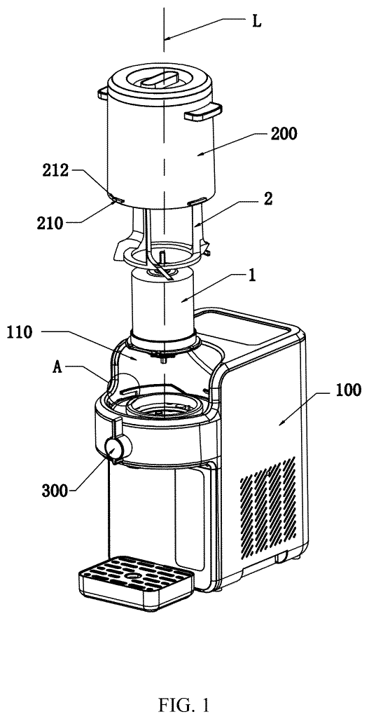

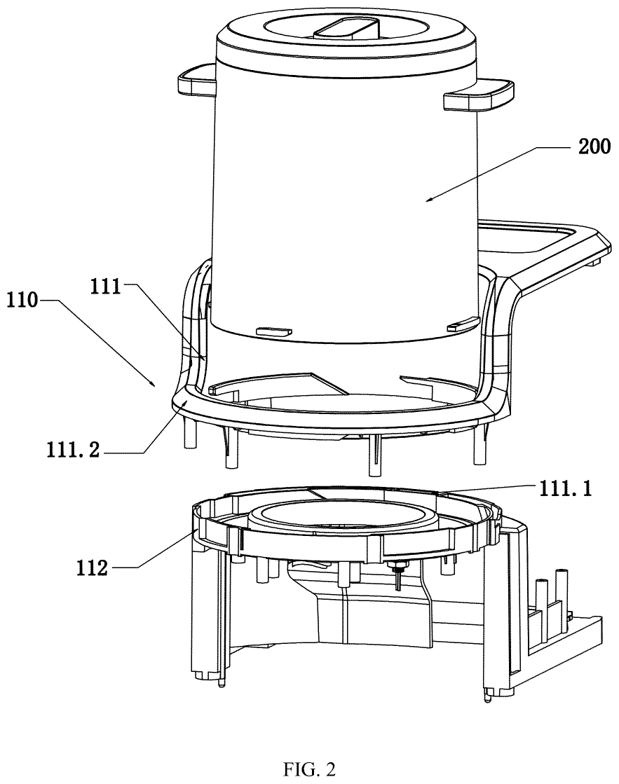

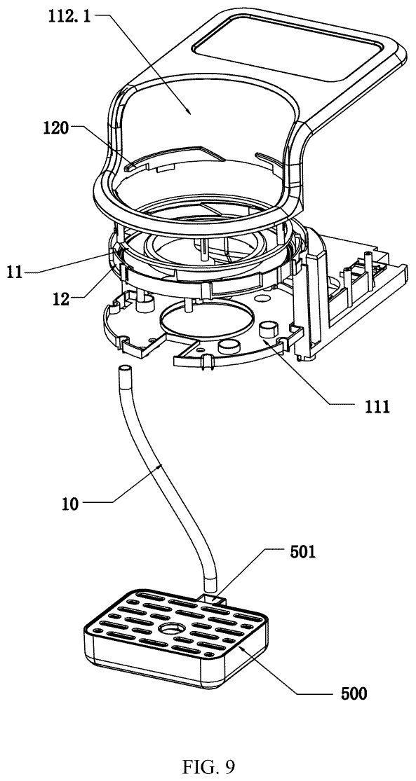

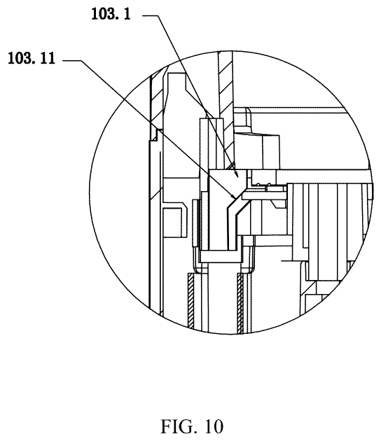

As shown in FIGS. 1-16, this embodiment discloses a vertical smoothie machine.

With specific reference to FIG. 1, a vertical smoothie machine includes:

The refrigeration device mainly consists of a compressor and an evaporator, and these two major components are integrated and installed in the internal structure of the main unit 100. The compressor compresses the gaseous refrigerant into a high-temperature and high-pressure state, and then transports it to the evaporator through a pipeline. The evaporator converts the refrigerant into a low-temperature liquid through heat exchange. These low-temperature refrigerating liquids are transferred to the inside of the ice-making cylinder 1 of the receiving base 110 through a special conveying pipeline, and the overall temperature of the ice-making cylinder 1 is rapidly decreased through heat conduction.

The refrigeration device mainly consists of a compressor and an evaporator, and these two major components are integrated and installed in the internal structure of the main unit 100. The compressor compresses the gaseous refrigerant into a high-temperature and high-pressure state, and then transports it to the evaporator through a pipeline. The evaporator converts the refrigerant into a low-temperature liquid through heat exchange. These low-temperature refrigerating liquids are transferred to the inside of the ice-making cylinder 1 of the receiving base 110 through a special conveying pipeline, and the overall temperature of the ice-making cylinder 1 is rapidly decreased through heat conduction.

During the ice-making process, the pre-prepared beverage stock solution is injected into the ice cup 200, and then evenly sprinkled on the outer wall surface of the ice-making cylinder 1. When the temperature of the ice-making cylinder 1 drops below the freezing point under the action of the refrigeration device, the beverage stock solution attached to the outer wall rapidly undergoes a phase change, transforming from a liquid state to a solid ice layer. At the same time, the transmission component driven by the motor drives the scraper 2 to rotate around the axis L. The blade of the scraper 2 maintains an appropriate contact pressure with the outer wall of the ice-making cylinder 1 to completely scrape off the ice layer that has solidified. The scraped ice layer naturally breaks under the action of gravity, forming fine smoothie particles, and gradually accumulates on the receiving base 110. During the rotation process, the scraper 2 continuously pushes the accumulated smoothie to the discharge port position of the discharge base, and finally completes the automated output of the smoothie product.

In this embodiment, the ice-making method and ice-scraping method of the smoothie machine are the same as those of the horizontally arranged smoothie machine in the prior art, and will not be described in detail here.

Before turning on the main unit 100, the user needs to install the ice cup 200 on the receiving base 110, isolate a beverage making chamber on the receiving base 110, so that the ice-making cylinder 1 and the scraper 2 are both located inside the ice cup 200, and isolate and protect the ice-making cylinder 1 and the scraper 2.

In order to confirm whether the ice cup 200 is installed in place, in this embodiment, the ice cup 200 and the receiving base 110 are locked and connected, and an activation device is provided to control the energization of the circuit system in the main unit 100;

The upper end of the activation component 14 extends above the receiving base 110 and is located on the installation path of the ice cup 200; the lower end of the activation component 14 corresponds to the activation button 13.1 of the micro switch 13.

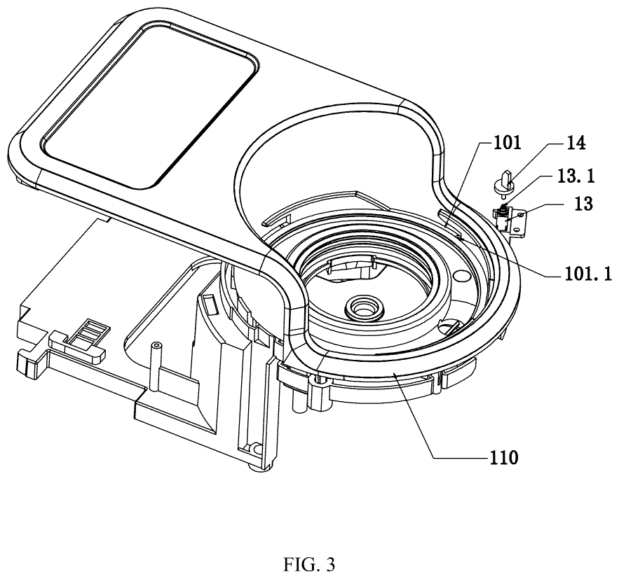

Specifically referring to FIG. 3, the micro switch 13 is installed in the main unit 100 through a bracket and is located below the receiving base 110. At the same time, in order to ensure that the micro switch 13 can be driven, the activation button 13.1 of the micro switch 13 is located directly below the installation path of the ice cup 200.

The discharge base 100 is provided with an avoidance hole 101.1, which is located above the activation button 13.1. An activation component 14 is arranged in the avoidance hole 101.1. The activation component 14 extends through the avoidance hole 101.1 to above the receiving base 110 and comes into contact with the ice cup 200. When the ice cup 200 is installed on the receiving base 110, it drives the activation component 14, causing the activation component 14 to move downward, so that the lower end of the activation component 14 presses the activation button 13.1, thereby activating the micro switch 13 and turning on the circuit in the main unit 100.

Preferably, in this embodiment, the avoidance hole 101.1 is arranged in the guide groove 101, and is preferably arranged at the terminal position of the guide groove 101. During the installation process of the ice cup 200, the guide block 210 on the ice cup 200 will slide smoothly along the track of the guide groove 101. When the guide block 210 slides to the terminal position of the guide groove 101, the guide block 210 will come into contact with the activation component 14 and apply a certain pressure, thereby driving the activation component 14. Only in this specific position will the activation component 14 receive sufficient driving force to trigger the action of the micro switch 13. This design ensures that the circuit will only be turned on after the ice cup 200 is fully installed in place, thereby effectively avoiding the problem of accidental circuit startup due to improper installation, greatly reducing potential safety hazards, and fully reflecting the product design's high attention to safety.

Preferably, in this embodiment, an inclined driving surface is provided on the upper end of the activation component 14, so that the guide block 210 can smoothly drive the activation component 14.

A plurality of guide blocks 210 extend from the outer periphery of the bottom of the ice cup 200, and a guide groove 101 capable of accommodating the guide blocks 210 sliding in is provided on the inner wall of the receiving base 110.

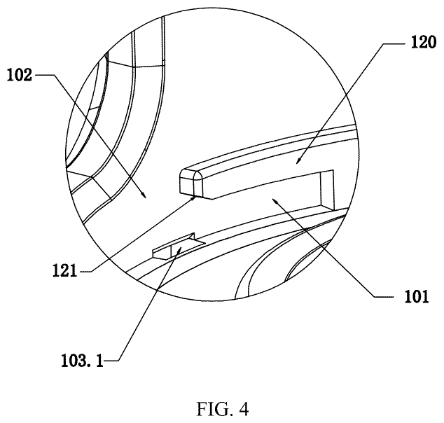

At the same time, referring to FIG. 4, in this embodiment, the guide groove 101 is arranged on the inner end face of the retaining wall 111.2 of the receiving base 110, and an arc-shaped groove capable of accommodating the guide block 210 is formed on the end face of the retaining wall 111.2 through the arc-shaped reinforcing rib 120. A plurality of protruding reinforcing ribs 120 are evenly distributed on the inner wall of the retaining wall 111.2 in the circumferential direction, and an entrance 102 of the guide groove 101 is formed between two adjacent reinforcing ribs 120. During installation, align the guide block 210 with the entrance 102 and push it downward into the guide groove 101 along the axial direction until the bottom end surface of the ice cup 200 is completely fitted to the contact surface of the receiving base 110. The bottom edges of these reinforcing ribs 120 and the end face of the receiving base 110 together form the guide groove 101. After the guide block 210 is initially placed, it is necessary to rotate the ice cup 200 to move the guide block 210 along the path of the guide groove 101, and finally turn into the locked position below the reinforcing rib 120. In this state, due to the blocking effect of the upper reinforcing rib 120, the guide block 210 is firmly restricted in the groove below the reinforcing rib 120, thereby effectively preventing the ice cup 200 from accidentally falling out of the receiving base 110 in the axial direction, ensuring stability and safety during use.

Preferably, the starting end of the guide block 210 along the rotation direction is provided with an inclined guide surface 212, and the introduction end of the guide groove 101 is provided with an introduction surface 121 that cooperates with the guide surface 212.

Slowly place the guide block 210 from the entrance 102 so that it is located at the starting end position of the guide groove 101, and gently rotate the ice cup 200 by a small angle. At this time, the inclined surfaces of the introduction surface 121 and the guide surface 212 will cooperate with each other to form an interaction surface with a specific inclination angle. As the ice cup 200 continues to rotate, the introduction surface 121 will gradually apply a squeezing force perpendicular to the guide surface 212 downward to the guide surface 212. This squeezing force can be decomposed into two directional components: one of which is a vertically downward force, which can effectively push the guide block 210 to move smoothly downward along the guide groove 101, so that the lower end surface of the ice cup 200 is tightly attached to the end surface of the receiving base 110, minimizing the assembly gap that may occur between the two. Based on this setting, it can ensure that a reliable sealing effect is formed between the ice cup 200 and the receiving base 110 to prevent liquid from seeping out.

In order to ensure the locking of the ice cup 200, in this embodiment, a locking protrusion may be provided on the end face of the guide block 210, and a locking groove that cooperates with the locking protrusion is provided on the receiving base 110.

In this embodiment, the receiving base 110 includes a discharge base 111 and a discharge cover 112, the upper end surface of the discharge base 111 forms an ice receiving surface a for receiving smoothie, and the discharge cover 112 has a retaining wall 111.2 for boundary delimitation of the ice receiving surface a;

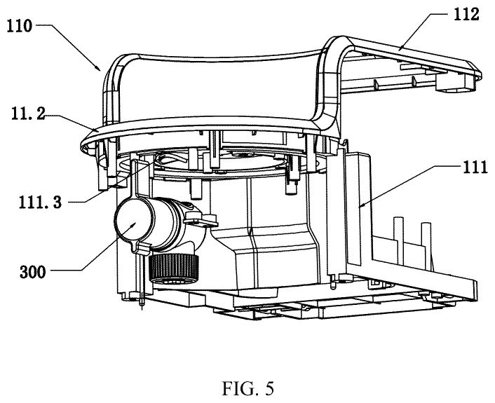

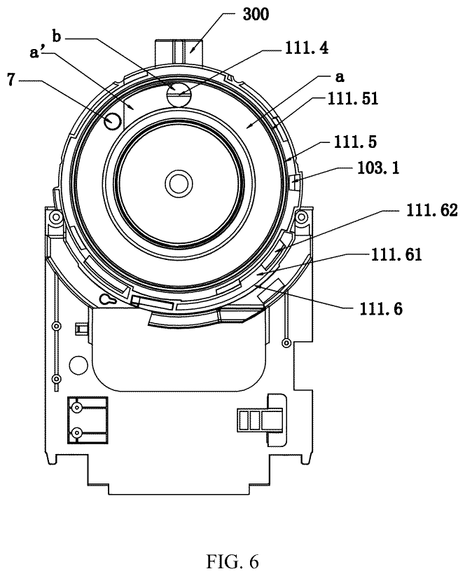

Specifically referring to FIGS. 5-6, a discharge pipe 111.3 for conveying smoothie is formed at the bottom of the receiving base 110. The scraper 2 pushes the prepared smoothie along a preset movement trajectory to the upper end port b position of the discharge pipe 111.3. At the lower end outlet of the discharge pipe 111.3, a distributor 300 is sealingly connected, which can accurately control the output amount of the smoothie. Finally, after this series of conveying processes, the smoothie will be uniformly and stably output to the designated container through the outlet of the distributor 300. The entire discharge system is reasonably designed, and the components are closely coordinated to ensure the smooth and efficient entire process from smoothie production to output.

The edge of the discharge base 111 is arranged in the main unit 100, and only the ice receiving surface a is exposed to the upper end surface of the main unit 100; at the same time, the discharge cover 112 is the end surface of the main unit 100, and has an annular structure for annularly wrapping the discharge base 111.

The discharge port b is directly arranged on the plane of the ice receiving surface a, and is at least flush with the ice receiving surface a. At the same time, the entire movement trajectory of the lower end of the scraper 2 is also limited to the range of the ice receiving surface a. When the scraper starts to operate and applies a rotational thrust to the smoothie, its movement path will naturally pass through the opening position of the discharge port b, and the smoothie will be brought into the discharge port b along the trend. The smoothie entering the discharge port b will smoothly enter the inside of the discharge channel under the action of gravity and channel guidance, completing the entire discharge process. This mechanical structure design ensures the continuity of smoothie conveying and realizes the automation of the discharge process.

Preferably, in this embodiment, the discharge channel is set as a through hole. In order to effectively prevent the safety hazard that children may accidentally insert their fingers or other small objects into the inside of the through hole due to curiosity, in this embodiment, a baffle rib 111.4 is provided in the discharge channel. Through physical isolation, the possibility of the operator's fingers or other foreign objects accidentally entering the inside of the equipment from the direction of the discharge port b is effectively prevented.

In addition, a guide area a′ is arranged on the outer periphery of the discharge port b. This guide area a′ is an inclined surface distributed radially to the surroundings, showing obvious slope changes: the inner side portion close to the discharge port b is set to a relatively low position, and as the direction away from the discharge port b, the height of the guide area a′ gradually increases, forming a continuous inclined surface from low to high.

Based on the above configuration, when the ice scraper pushes the shaved ice to the guiding area a′, due to the physical characteristics of the inclined surface of the guiding area a′, the shaved ice will naturally tend to slide down under the action of gravity. This guiding effect allows the shaved ice to slide smoothly along the inclined surface, thereby promoting a large amount of shaved ice to automatically and continuously gather and move towards the discharge port b, effectively improving the efficiency and uniformity of shaved ice conveying.

In this embodiment, in order to control the temperature inside the beverage making chamber to better produce the required low-temperature beverage, a temperature control probe 7 is also provided on the ice receiving surface a, and the detection surface of the temperature control probe 7 is flush with the ice receiving surface a.

Preferably, in this embodiment, the temperature control probe 7 is located outside the guiding area a′.

The temperature control probe 7 is mainly used to monitor the temperature change of the shaved ice mixture falling onto the ice receiving surface a in real time from the ice maker. Based on this configuration, it can be ensured that the sensing end of the temperature control probe 7 remains completely flush with the ice receiving surface a, thereby avoiding measurement errors caused by height differences; and, since the temperature control probe 7 is located outside the guiding area a′, it can contact the shaved ice that is about to be output, so it can monitor the beverage temperature closest to the actual output temperature in real time. The selection of this installation position not only complies with equipment installation specifications, but also provides the most accurate temperature data, providing a reliable guarantee for beverage quality control.

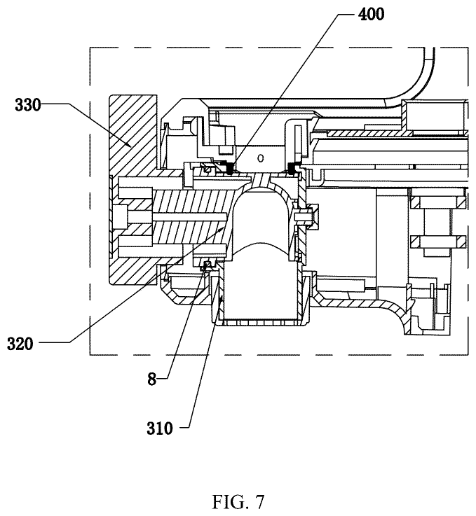

In order to ensure the seal between the dispenser 300 and the discharge pipe 111.3, in this embodiment, referring specifically to FIG. 7, a sealing ring 400 is provided between the discharge pipe 111.3 and the feed port b of the dispenser 300; the sealing ring 400 covers the outer circumference of the discharge pipe 111.3 and abuts against the edge of the feed port b of the dispenser 300. When the shaved ice is output from the discharge channel and enters the feed port b of the dispenser 300, it is always in a completely sealed channel, effectively preventing the leakage of shaved ice or the entry of external pollutants. The design of the entire sealing system considers both the convenience of installation and the reliability of sealing during use.

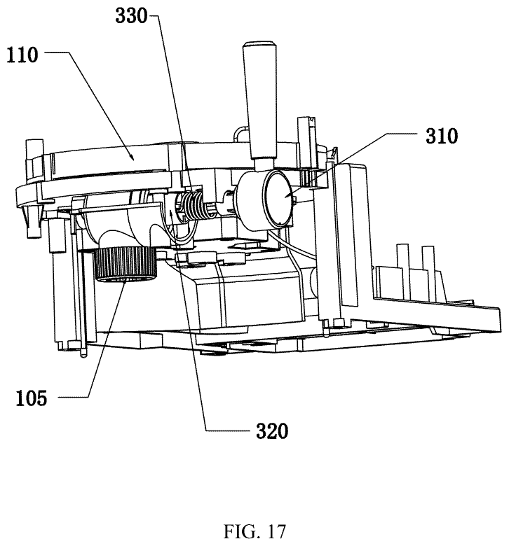

This embodiment also provides an automatic reset structure of the dispenser 300. Referring specifically to FIG. 17, the dispenser 300 is arranged below the receiving base 110, including an operating handle 310 and a valve body 320 driven by the operating handle 310. The valve body 320 is provided with a through hole communicating with the discharge channel and the discharge port 105 on the main unit 100. The operating handle 310 drives the valve body 320 to rotate, misaligning the through hole and the discharge port 105, so that the dispenser 300 cannot discharge. The valve body 320 is provided with a torsion spring 330, the torsion spring 330 is sleeved on the connecting rod on the side of the valve body 320, and the two torsion feet abut against the receiving base 110 and the valve body 320 respectively. When the user rotates the operating handle 310, the through hole in the valve body 320 communicates with the discharge channel and the discharge port 105, so that the produced shaved ice can be discharged, and the torsion spring 330 is in a twisted state at this time. After the external force on the operating handle 310 is removed, the restoring torsion force of the torsion spring 330 drives the valve body 320 and the operating handle 310 to reset, so that the valve body 320 is in a state of closing the discharge port 105, avoiding the shaved ice from falling outside the container due to forgetting to close the dispenser 300 after use.

In this embodiment, the receiving base 110 is provided with an external drainage structure and an internal drainage structure. The external drainage structure is located inside the receiving base 110 and drains the condensed water liquefied on the outer wall of the ice cup 200; the internal drainage structure is located inside the main unit 100 and drains the condensed water liquefied at the bottom 110 of the discharge base.

Specifically, the external drainage structure includes a first condensed water channel 103 formed on the receiving base 110, the first condensed water channel 103 is located around the ice cup 200; and the first condensed water channel 103 is provided with a first drain outlet 103.1, the first drain outlet 103.1 is connected to the drain outlet 501 of the main unit 100 through a drain pipe 1. 0

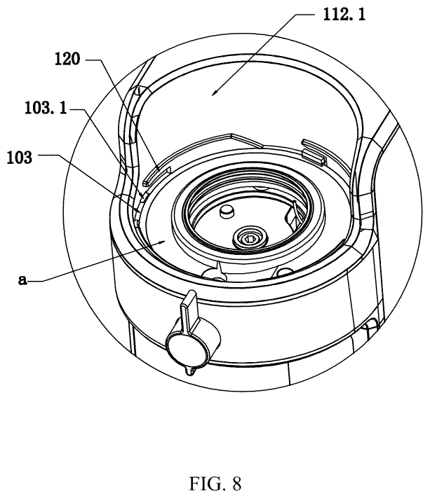

Referring specifically to FIGS. 8-10, two sets of drainage systems, an internal drainage structure and an external drainage structure, are arranged on the receiving base 110 in cooperation with each other. Among them, the external drainage structure is mainly responsible for handling the condensed water generated on the outer surface of the ice cup 200, and can efficiently guide and discharge the condensed water droplets on the outer wall of the ice cup 200, avoiding the condensed water from flowing along the outer wall of the main unit. At the same time, the internal drainage structure is specially used for handling the condensed water generated inside the main unit 100, and its specific action position is the bottom of the receiving base 110. When the receiving base 110 receives the shaved ice, the temperature drops rapidly, and the air inside the main unit 100 located below the receiving base 110 encounters the low-temperature bottom surface of the receiving base 110, and quickly liquefies to form water droplets condensed on the bottom of the receiving base 110. When too much condensed water condenses, it drips onto the internal drainage structure under the action of gravity. The internal drainage structure collects and exports the dripped condensed water, effectively preventing the condensed water from flowing arbitrarily inside the main unit 100, avoiding the adverse effects of moisture on the precision components inside the main unit 100, and ensuring the long-term stable operation of the refrigeration system.

The receiving base 110 is provided with an ice receiving surface a for receiving condensed water. When the ice cup 200 completely covers the receiving base 110, this ice receiving surface a is naturally separated into an internal area and an external area by the bottom of the ice cup 200. The internal area is located directly below the ice cup 200 and is mainly used to receive the finished shaved ice cut off from the outside of the ice making cylinder 1; while the external area is a complete ring structure formed around the outer edge of the ice cup 200, and this ring space constitutes the first condensed water channel 103.

During the ice making process, the inside of the ice cup 200 maintains an extremely low temperature due to the continuous production of shaved ice, which forms a significant temperature difference with the normal temperature air outside the ice cup 200. This temperature difference effect causes the water vapor in the air around the outer wall of the ice cup 200 to continuously cool and liquefy, forming a large amount of condensed water droplets on the outer surface of the ice cup 200. These condensed water naturally slide down under the action of gravity and are completely collected by the first condensed water channel 103.

In order to ensure that the condensed water can be effectively discharged, the first condensed water channel 103 is specially provided with a first drain outlet 103.1, and the first drain outlet 103.1 guides the collected condensed water into the drain pipe. The drain pipe 10 is arranged vertically, and the gravity self-flow principle is used to finally guide the condensed water smoothly to the drain outlet 501 at the bottom of the main unit 100 for centralized discharge, thereby maintaining the dryness and cleanliness of the surrounding environment of the equipment. 10

In this embodiment, when the ice making is completed and the user takes out the ice cup 200 from the receiving base 110, at this time, a small amount of condensed water in the internal area of the receiving base 110 will flow outward, and can also be collected through the first drain outlet 103.1.

During the ice making process, when the user puts raw materials into the ice cup 200, a small amount of raw materials splashed outside the ice cup 200 can also be collected through the first condensed water channel 103.

Preferably, an inclined water guiding surface 103.11 is provided inside the first drain outlet 103.1.

The opening of the first drain outlet 103.1 is arranged at the bottom surface position of the first condensed water channel 103, and the water guiding surface 103.11 is formed in the internal space of the first drain outlet 103.1, and adopts a method of gradually inclining from the outer edge of the opening to the central area to form a smooth transition inclined surface extending downward, which can effectively capture and guide the condensed water flowing down from the edge area of the opening.

Based on the above configuration, through the guiding effect of the inclined surface, the condensed water dispersed on the edge of the opening will be gradually gathered, and finally concentrated to flow to the center position of the first drain outlet 103.1, realizing an orderly and concentrated drainage function, which not only improves the drainage efficiency, but also avoids the accumulation of condensed water on the edge, ensuring the stable operation of the entire drainage system.

In order to prevent the condensed water in the first condensed water channel 103 from seeping into the beverage making chamber through the gap between the bottom of the ice cup 200 and the ice receiving surface a, in this embodiment, a sealing gasket 9 is provided between the bottom of the ice cup 200 and the receiving base 110, and the sealing gasket 9 is flush with the first drain outlet 103.1.

In other embodiments, the sealing gasket 9 may also be slightly higher than the position of the first drain outlet 103.1 to ensure that the sealing gasket 9 and the lower end of the ice cup 200 can be tightly abutted.

The receiving base 110 is provided with a sealing groove 111.3, and the sealing gasket 9 is embedded in the sealing groove 111.3 and is flush with the groove opening of the sealing groove 111.3;

In this embodiment, the internal drainage structure is:

The internal drainage structure includes a water receiving base 12 arranged below the receiving base 110 and located inside the main unit 100, for receiving the condensed water dripping from the bottom of the receiving base 110;

The water receiving base 12 is provided with a second drain outlet 12.2 and the drain pipe 10 is connected.

Specifically, a water receiving base 12 is arranged in the discharge base to receive the condensed water formed on the bottom surface of the ice receiving surface a.

In this embodiment, the receiving base 110 includes a discharge base 111 and a discharge cover 112, and the upper end surface of the discharge base 111 forms an ice receiving surface a for receiving shaved ice, and the discharge cover 112 has a discharge wall 112.1 for delimiting the boundary of the ice receiving surface a.

The water receiving base 110 is arranged below the discharge base 111, that is, below the ice receiving surface a, and a water receiving groove 12.2 is formed between the water receiving base 110 and the lower end surface of the discharge base 111.

The water receiving base is integrally installed directly below the receiving base 110, and its structural design ensures that it can completely cover the area below the 12 ice receiving surface a. The water receiving groove 111.61 is formed on the upper end surface of the water receiving base, and a water pipe interface is formed at the bottom of the second drain outlet 12.2, and the drain pipe is connected to the 10 water pipe interface to form a complete drainage channel.

Based on the above configuration, the condensed water discharged from the two drain outlets can smoothly enter the drain pipe, effectively avoiding the problem of condensed water dripping.

The ice receiving surface a is located on the upper end surface of the discharge base 111. During the ice making process, the shaved ice falls onto the ice receiving surface a, causing the discharge cover to cool down rapidly. The air located below the discharge base 111 encounters the cooled discharge base 111 and condenses into water droplets attached to the lower end surface of the discharge base 111. When the water droplets condense to a certain amount, they drip onto the water receiving base 12 under the action of gravity, thereby being collected by the water receiving base 12 and discharged through the second drain outlet 12.2.

Preferably, in this embodiment, a second condensate water channel 104 is arranged around the first condensate water channel 103, the second condensate water channel is an arc-shaped groove 104, and a third drain outlet 104.1 is arranged in the second condensate water channel 104.

In this embodiment, the upper outer shape of the main unit 100 adopts a stepped structure, wherein the ice receiving surface a is located at a lower step position, and a vertical side wall connected to the upper end surface of the main unit 100 extends from the side of the receiving base 110. The side wall is the discharge wall 112.1, and the discharge wall 112.1 is arranged adjacent to the ice cup 200. Due to this structural layout, when the temperature of the ice cup 200 gradually decreases under the cooling effect of the ice making cylinder 1, the air layer between the outer wall of the ice cup 200 and the discharge wall 112.1 will continuously exchange heat, resulting in a decrease in the temperature of the outer surface of the discharge wall 112.1. The inner side of the discharge wall 112.1 is directly connected to the internal space of the main unit 100. When the water vapor in the air inside the main unit 100 encounters the discharge wall 112.1 with a lower temperature, liquefaction will occur, forming condensed water droplets. These condensed water droplets slide down along the inner surface of the discharge wall 112.1 under the action of gravity, and finally drip into the interior of the main unit 100, which may cause moisture damage to the electronic components inside the main unit 100, thereby affecting the normal operation and service life of the equipment.

Therefore, in order to collect the condensed water on the inner surface of the discharge wall 112.1, the structure of the arc-shaped groove is consistent with the structure of the side wall, and the lower end of the discharge wall 112.1 is connected to the arc-shaped groove, and the condensed water formed on the inner surface of the discharge wall 112.1 is collected into the arc-shaped groove along the inner surface.

Based on the above arrangement, the outer drain structure can not only receive the condensed water on the outer wall of the ice cup 200, but also receive the condensed water on the outer wall of the discharge wall 112.1.

In order to enable the first drain outlet 103.1 and the second drain outlet 12.2 to be jointly connected to the drain pipeline, in this embodiment, the first drain outlet 103.1 extends towards the second drain outlet 12.2 with a water guiding pipe, and a gap is formed between the water guiding pipe and the edge of the second drain outlet 12.2.

Preferably, in order to ensure that the condensed water in the water receiving base 12 can enter the second drain outlet 12.2, in this embodiment, the size of the second drain outlet 12.2 is larger than the size of the lower end of the water guiding pipe, so that a gap is left between the second drain outlet 12.2 and the water guiding pipe, so that the condensed water in the water receiving base 12 can enter the second drain outlet 12.2 and be discharged.

In this embodiment, a water receiving box 500 is arranged at the front end of the main unit 100, and the drain outlet 501 is arranged on the water receiving box 500.

In this embodiment, the scraper 2 is: the scraper 2 includes a scraping strip 2.1 extending along the axial direction of the ice making cylinder 1, the lower end of the scraping strip 2.1 is provided with an ice shovel 2.2, and the ice shovel 2.2 and the ice receiving surface a of the shaved ice machine are arranged at an acute angle.

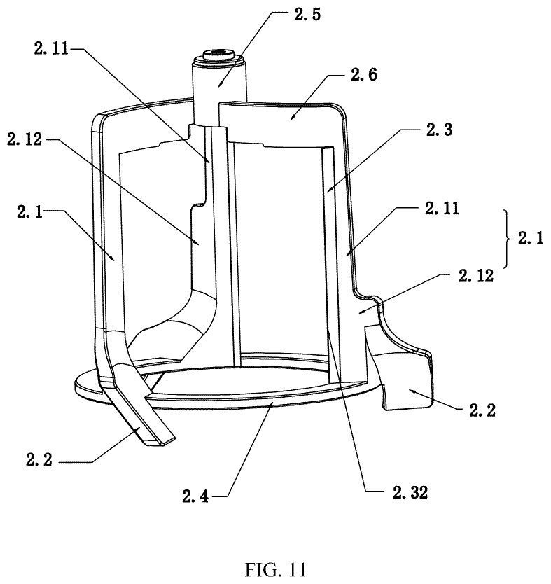

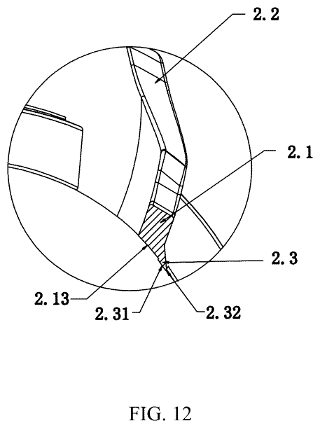

Specifically referring to FIG. 11-FIG. 12, the ice making cylinder 1 adopts a vertical layout structure design, and its axis Lis installed vertically perpendicular to the horizontal plane. The scraper 2 is located in the external space of the cylinder body of the ice making cylinder 1, and the scraping strip 2.1 is arranged in parallel along the extending direction of the axis L of the ice making cylinder 1, and the inner end surface thereof maintains a very small gap distance from the outer wall surface of the ice making cylinder 1. When the motor drives the scraper 2 to rotate, the blade portion of the scraping strip 2.1 will continuously rub against the ice layer condensed on the outer wall surface of the ice making cylinder 1. Through this mechanical scraping action, the shaved ice attached to the outer wall of the ice making cylinder 1 can be effectively peeled off.

The shaved ice particles scraped down by the scraping strip 2.1 fall freely under the action of gravity, and finally reach the specially designed ice receiving surface a at the bottom of the shaved ice machine. In this process, the ice shovel 2.2, which operates synchronously with the scraping strip 2.1, also performs a coaxial rotation movement around the axis L. The shovel surface of the ice shovel 2.2 applies a continuous lateral thrust to the shaved ice falling to the ice receiving surface a. This pushing force can gradually push the loose shaved ice particles along the inclined direction of the ice receiving surface a to the discharge port position located at the edge of the ice receiving surface a, completing the entire process of shaved ice collection and transportation.

When the scraper 2 structure rotates clockwise, an acute angle space is formed between the blade surface of the ice shovel 2.2 and the ice receiving surface a in the forward direction of the rotation movement. The ice sweeping space formed by this structure can effectively drive the shaved ice particles in a directional manner with a mechanical movement similar to “sweeping the floor”.

When the scraper 2 structure rotates clockwise, an acute angle space is formed between the blade surface of the ice shovel 2.2 and the ice receiving surface a in the forward direction of the rotation movement. The ice sweeping space formed by this structure can effectively drive the shaved ice particles in a directional manner with a mechanical movement similar to “sweeping the floor”.

When the scraper 2 rotates counterclockwise, an obtuse angle is formed between the blade surface of the ice shovel 2.2 and the ice receiving surface a in front. Under this structure, the front end of the blade surface can cut into the surface of the ice layer and pry up the ice layer. The end surface of the ice shovel 2.2 pushes the loosened shaved ice particles forward through continuous rotation movement, thereby achieving an efficient ice surface cleaning effect. This design cleverly utilizes the mechanical characteristics generated by the rotation movement, so that the ice shovel 2.2 can complete the continuous removal operation of the shaved ice while maintaining stable contact, effectively improving the ice breaking efficiency.

The advantage of inclining the ice shovel 2.2 is that the acute angle structure enables the ice shovel 2.2 to contact the ice surface at the best cutting angle, which ensures the ice breaking force and avoids unnecessary energy loss. The cooperation of this driving method and angle design helps to push the shaved ice to the discharge port, speed up the discharge, and ensure the stability and efficiency of the equipment in the ice removal operation.

In order to improve the ice scraping efficiency, in this embodiment, a scraping blade 2.3 is arranged on one side of the scraping strip 2.1 along the circumferential direction, and the inner end surface of the scraping blade 2.3 is set as a protruding scraping surface 2.31 attached to the surface of the ice making cylinder 1.

In this embodiment, the inner end surface of the scraping strip 2.1 is set as a working surface 2.13 that matches the surface contour of the ice making cylinder 1. The working surface 2.13 is processed with a curvature to ensure that it maintains the best contact state with the ice making cylinder 1. At the same time, in order to ensure the safety and flexibility during the ice removal process, a buffer gap is intentionally reserved between the working surface 2.13 and the ice making cylinder 1 to avoid the working surface 2.13 directly contacting the ice making cylinder 1 and causing the working surface 2.13 to directly scratch the surface of the ice making cylinder 1. The scraping blade 2.3 is integrally formed on one side of the scraping strip 2.1, and its inner end surface is designed as a scraping surface 2.31 protruding relative to the working surface 2.13. This stepped height difference design can reduce resistance, improve work efficiency, and ensure effective scraping of the ice layer during scraping, and can avoid damage to the surface of the ice making cylinder 1.

Preferably, in order to increase the cutting efficiency of the scraping blade 2.3 on the ice layer, in this embodiment, the side of the scraping blade 2.3 away from the scraping strip 2.1 is set as a scraping edge 2.32 with a blade structure.

In this embodiment, one side of the scraping strip 2.1 is designed as a sharp blade-like structure, which significantly enhances the mechanical strength of the scraping strip 2.1, so that it can withstand and overcome greater ice scraping resistance; and makes the scraping edge 2.32 form a sharper contact angle with the cylindrical surface of the ice making cylinder 1. Compared with the traditional flat scraping strip 2.1, its scraping end is more sharp and protruding; this optimized geometric structure ensures that the scraping strip 2.1 forms the best contact state with the surface of the ice making cylinder 1, thereby greatly improving the efficiency of scraping the ice layer, and making the overall scraping effect reach a more ideal state.

During the rotation of the scraper 2, the scraping strip 2.1 will generate a large amount of fine shaved ice when cutting the ice layer. Most of these shaved ice will naturally fall off, but a small amount will adhere to the surface of the scraping strip 2.1 due to surface tension. As the cutting operation continues, these adhered shaved ice will gradually accumulate to form a thin layer. If the accumulation amount exceeds the critical value, these loose shaved ice will re-condense and solidify in a low-temperature environment, and finally form hard ice blocks. This ice block will not only increase the running resistance of the scraping strip 2.1, but also significantly reduce the contact pressure between the scraping strip 2.1 and the ice layer, thereby seriously affecting the scraping efficiency and service life of the scraping strip 2.1 on the surface ice layer of the ice making cylinder 1. Therefore, in this embodiment, the outer end surface of the scraping strip 2.1 is set as a stepped structure.

Based on the above arrangement, when the shaved ice continuously accumulates on the end surface of the scraping strip 2.1 and reaches the critical adhesion amount, since the end surface of the scraping strip 2.1 has been completely covered by the shaved ice and reaches a saturated state, its surface cannot continue to carry and adhere more shaved ice particles. At this time, the adhesion between the shaved ice and the scraping strip 2.1 has reached the limit, and under the combined influence of gravity and mechanical vibration, the shaved ice will naturally fall off from the surface of the scraping strip 2.1. By designing the scraping strip 2.1 as a stepped structure with obvious height difference, the actual width dimension of the upper part of the scraping strip 2.1 can be significantly reduced. This structural design can effectively reduce the contact area and adhesion area of the shaved ice on the upper part of the scraping strip 2.1; at the same time, the lower part of the scraping strip 2.1 adopts a relatively large width design. This structural configuration not only ensures the stability of the overall structure of the scraping strip 2.1, but also ensures that the scraping strip 2.1 has sufficient mechanical support strength and anti-deformation ability during the working process, thereby meeting the requirements for long-term stable operation of the equipment.

In this embodiment, in order to further enhance the strength of the scraping strip 2.1 and ensure the pushing efficiency of the ice shovel 2.2, a reinforcing ring 2.4 is arranged at the lower end of the scraping strip 2.1, and the reinforcing ring 2.4 is located inside the ice shovel 2.2 for connecting multiple scraping strips 2.1.

In this embodiment, the scraper 2 also includes a driving shaft 2.5 connected to the motor, and a connecting rib 2.6 extending radially from the circumferential surface of the driving shaft 2.5, and the scraping strip 2.1 is connected to the outer end of the connecting rib 2.6;

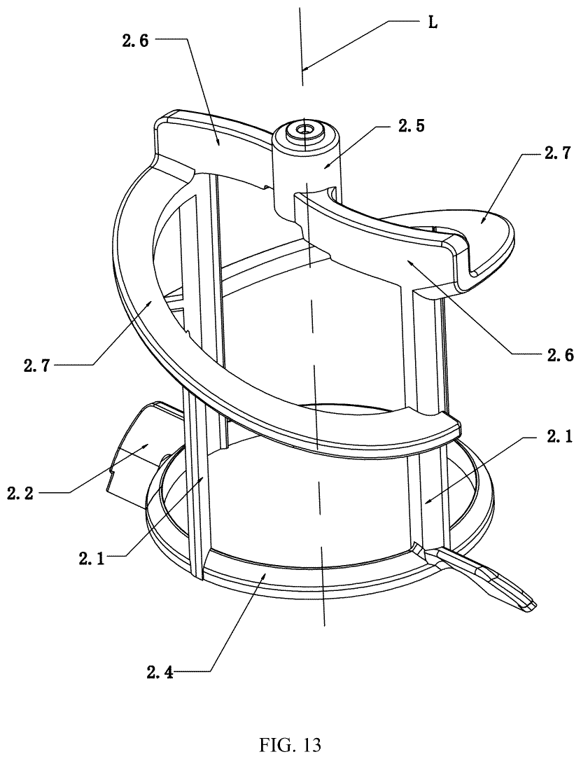

Referring to FIG. 13, in other embodiments, the outer end of the connecting rib 2.6 is connected with a spiral scraper 2.7; the scraping strip 2.1 is connected to the connecting rib 2.6 or the spiral scraper 2.7.

In this embodiment, the spiral scraper 2.7 maintains a very small gap with the surface of the ice making cylinder 1, with the two being in near zero-distance contact, such that the spiral scraper 2.7 can efficiently and precisely cut the ice layer formed on the surface of the ice making cylinder 1. The cut ice shavings will rotate and slide down along the specially designed spiral surface of the spiral scraper 2.7, and finally be smoothly guided to the ice receiving surface a below.

Preferably, the number of ice scraping strips 2.1 is the sum of the number of connecting ribs 2.6 and the number of spiral scrapers 2.7.

In this embodiment, an ice cup with good stirring effect is also provided, which is:

The inner wall of the ice cup is provided with ribs extending along its axial direction for scraping off the ice layer covering the ribs, and the width of the ribs is gradually reduced along the ice outlet direction of the ice making cylinder, so that the outer surface of the ribs gradually moves away from the central axis of the ice making cylinder.

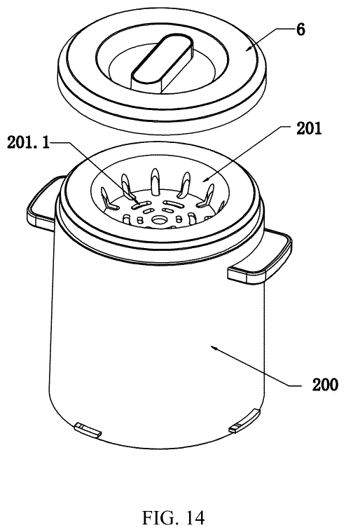

In this embodiment, the ice cup can be set as a transparent cup, and, referring to FIG. 14, the upper end of the ice cup 200 is recessed to form a feeding groove 201, and the bottom of the feeding groove 201 is provided with a feeding hole 201.1;

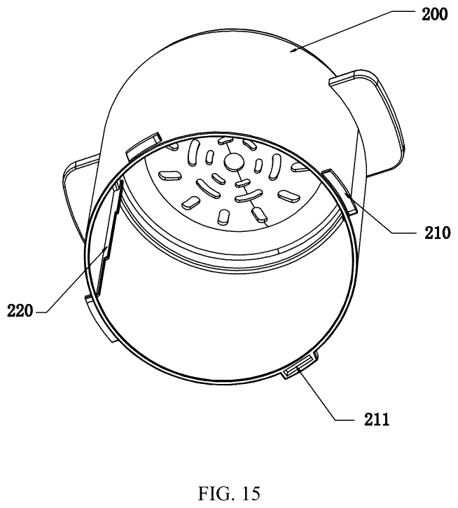

Specifically referring to FIG. 15, the ribs 220 are arranged radially on the inner wall of the ice cup 200, the rotation path of the scraper 2 corresponds to the outer surface of the ribs 220, and the width of the ribs 220 is gradually reduced along the ice outlet direction of the ice making cylinder 1, and the width of the ribs 220 is gradually reduced along the direction of the opening end of the ice making cylinder 1, so that the outer surface of the ribs 220 gradually moves away from the central axis of the ice making cylinder 1. The ribs 220 form a structure that is narrow at the top and wide at the bottom (viewed from the opening end of the ice making cylinder 1) to facilitate demolding of the ice. Since the ribs 220 are composed of wide and narrow structures, when the ice layer has slight shrinkage due to low temperature or stress due to scraping, it will be easier to loosen and detach from the wider part to the narrower part. Especially when the ribs 220 are arranged vertically, the ice layer is more likely to loosen and fall off due to gravity, which reduces the meshing effect of the ice layer on the inner wall of the ice making cylinder 1, so that the scraper 2 reduces the torque and resistance required for ice scraping, which not only makes the ice layer easier to be scraped off by the scraper 2, but also reduces the motor load and makes the operation more stable.

Preferably, in this embodiment, the ribs 220 are distributed in a stepped manner and form a plurality of discontinuous stepped sections. The stepped shape will produce a sudden change point in width at the corner of the step. When the ice layer condenses and wraps the step, a huge stress concentration will occur at the corner of the step. After the scraper 2 applies force, the ice layer will preferentially break from these discontinuous step corners and the top of the ribs 220, thereby naturally breaking into small ice pieces of uniform size, making the ice layer easier to be scraped off by the scraper 2. In addition, the discontinuous small ice pieces generated by the stepped section have better fluidity and are easier to be transported and discharged by the scraper 2, preventing the phenomenon that the ice shavings rotate synchronously along the concentric circle of the ice making cylinder 1 and cannot be scraped off by the stirring scraper head, and the ice shavings in this form are more fluffy and the taste is closer to the ideal “snowflake” shape, avoiding the problems of agglomeration or compaction caused by the ice shavings being too long, effectively improving the uniformity of the ice material stirring, and making the final ice product finer.

Preferably, the transition part between the stepped sections is an inclined surface. Through the above design, the above-mentioned fracture mutation point is transformed into a gradient point, and the smooth inclined surface transition eliminates the mutation of working resistance, makes the running torque of the motor more stable, significantly reduces noise and vibration, and reduces the wear of the impact on the parts, improves the reliability and life of the whole machine, and guides the ice layer to tear smoothly and assists the ice shavings to lift, so as to achieve a more stable and efficient operating state.

In this embodiment, the ice making cylinder 1 includes an inner cylinder 1.1 and an outer cylinder 1.2 sleeved on the inner cylinder 1.1, and a refrigeration cavity is formed between the inner cylinder 1.1 and the outer cylinder 1.2;

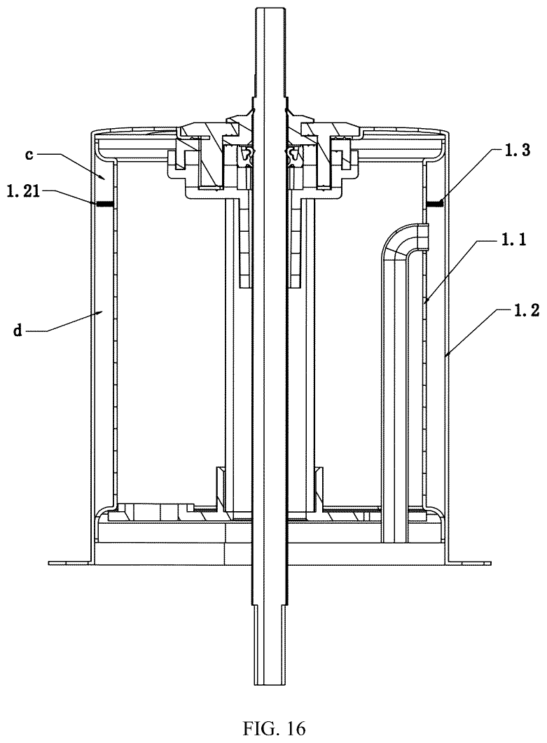

Specifically referring to FIG. 16, the annular baffle rib 1.3 and the inner cylinder 1.1 and the outer cylinder 1.2 jointly define an input cavity c and an output cavity d located on both sides of the annular baffle rib 1.3, respectively. The input cavity c is provided with a liquid inlet hole, the output cavity d is provided with a vent hole, and an overflow port 1.21 is arranged between the input cavity c and the output cavity d. The input cavity c and the output cavity d are only fluidly connected through the overflow port 1.21, so that the refrigerant has a first flow path in which the refrigerant enters the input cavity c through the liquid inlet hole and diffuses circumferentially along the outer wall of the inner cylinder 1.1 and the inner wall of the outer cylinder 1.2, and a second flow path in which the refrigerant enters the input cavity c through the liquid inlet hole, enters the output cavity d through the overflow port 1.21, and is discharged through the vent hole after evaporation.

Based on the above arrangement, the second flow path ensures that the refrigerant can directly and quickly enter the evaporation stage, and the first flow path uses the fluid's own characteristics to guide part of the refrigerant to spread circumferentially to both sides along the outer wall of the inner cylinder 1.1 and the inner wall of the outer cylinder 1.2, effectively activating the heat exchange surface that is prone to become a “dry burning zone” in the traditional structure, so that the refrigerant can cover a wider heat exchange area, greatly improving the uniformity of distribution, thereby improving the heat exchange efficiency of the evaporator as a whole; In addition, the dual-cavity structure can be realized only through the layout of the inner cylinder 1.1, the outer cylinder 1.2 and the annular baffle rib 1.3, which not only simplifies the manufacturing and assembly process and reduces the production cost, but also reduces the failure points and flow resistance that may be brought about by the complex internal structure, and improves the reliability and service life of the product.

Preferably, the overflow port 1.21 is a gap between the annular baffle rib 1.3 and the outer cylinder 1.2. Through the above structure, the distribution and flow of the refrigerant between the two cavities is reliably realized with a simple structure and low manufacturing cost, providing a structural basis for the efficient and uniform heat exchange of the evaporator.

In other embodiments, the overflow port 1.21 can also be set as a notch on the annular baffle rib 1.3 to connect the input cavity c and the output cavity d.

Moreover, in this embodiment, preferably, the input cavity c is located above the output cavity d, and the second flow path is a flow path in which the flow enters the output cavity d vertically downward from the overflow port 1.21. The annular baffle rib 1.3 is arranged in the upper region of the inner cylinder 1.1, so that the volume of the input cavity c is smaller than the volume of the output cavity d, and the vent hole is close to the annular baffle rib 1.3. The input cavity c and the output cavity d distributed in the vertical direction enable the part of the liquid refrigerant located in the input cavity c to fall to the output cavity d under the action of gravity, and the refrigerant that is heated and evaporated into gas expands in volume and decreases in density, thereby generating buoyancy to flow upward, so that it flows out from the vent hole located above. Setting the vent hole close to the annular baffle rib 1.3 is to avoid the refrigerant that is not fully heated and is in a liquid state from flowing out of the vent hole, ensuring that the refrigerant exchanges heat efficiently and uniformly.

The above descriptions are only preferred embodiments of the present utility model, and are not intended to limit the present utility model in any form. Although the present utility model has been disclosed as above with preferred embodiments, it is not intended to limit the present utility model. Any person skilled in the art can use the above-disclosed technical content to make some modifications or modifications into equivalent variations of equivalent embodiments without departing from the scope of the technical solution of the present utility model. However, any brief modification, equivalent variation and modification made to the above embodiments based on the technical essence of the present utility model without departing from the content of the technical solution of the present utility model shall still fall within the scope of the technical solution of the present utility model.

What is claimed is:

1. A vertical slush machine, comprising:
a main unit (100), wherein a refrigeration device is provided inside the main unit (100), and a receiving base (110) is formed at the front of the main unit (100);
an ice-making cylinder (1), vertically installed inside the receiving base (110);
a scraper (2), sleeved on the outside of the ice-making cylinder (1), and configured to be driven by a driving component to rotate around the axis L relative to the ice-making cylinder (1);
an ice cup (200), installed on the receiving base (110), completely covering the ice-making cylinder (1), and combined with the receiving base (110) to form a beverage making chamber.

2. The vertical slush machine according to claim 1, characterized in that: the ice cup (200) and the receiving base (110) are locked together, and an activation device is provided to control the power supply of the circuit system in the main unit (100);
wherein the activation device includes a micro switch (13) provided in the main unit (100), and an activation component (14) is provided through the receiving base (110).

3. The vertical slush machine according to claim 2, characterized in that: an upper end of the activation component (14) extends above the receiving base (110) and is located on the installation path of the ice cup (200), and a lower end of the activation component (14) corresponds to the activation button (13.1) of the micro switch (13).

4. The vertical slush machine according to claim 2, characterized in that: a plurality of guide blocks (210) extend from the outer circumference of the bottom of the ice cup (200), and a guide groove (101) capable of accommodating the guide blocks (210) is provided on the inner wall of the receiving base (110).

5. The vertical slush machine according to claim 1, characterized in that: the receiving base (110) includes a discharge base (111) and a discharge cover (112), the upper end surface of the discharge base (111) forms an ice-receiving surface (a) for receiving slush, and the discharge cover (112) has a barrier (111.2) that defines the boundary of the ice-receiving surface (a);
the receiving base (110) is provided with a discharge channel, and the discharge opening (b) of the discharge channel is formed on the ice-receiving surface (a); a baffle (111.4) is provided in the discharge channel;
a guiding area (a′) is provided on the ice-receiving surface (a) around the discharge opening (b), and the guiding area (a′) is arranged as an inclined surface radiating outwards from the discharge opening (b) as the lowest point;
a temperature control probe (7) is also provided on the ice-receiving surface (a);
a dispenser (300) is provided at the output end of the discharge channel.

6. The vertical slush machine according to claim 1, characterized in that: the receiving base (110) is provided with an external drainage structure and an internal drainage structure, the external drainage structure is located inside the receiving base (110) and drains the condensed water liquefied on the outer wall of the ice cup (200); the internal drainage structure is located inside the main unit (100) and drains the condensed water liquefied at the bottom of the receiving base (110);
wherein the external drainage structure includes a first condensate channel (103) formed on the receiving base (110); the first condensate channel (103) is located around the ice cup (200); and the first condensate channel (103) has a first drain opening (103.1), which is connected to the drain port (501) of the main unit (100) through a drainage pipeline (10).

7. The vertical slush machine according to claim 6, characterized in that: the internal drainage structure includes a water receiving base (12) located below the receiving base (110) and inside the main body (100), used to collect condensed water dripping from the bottom of the receiving base (110);
wherein the water receiving base (12) is provided with a second drain outlet (12.2) and is connected to the drainage pipeline (10).

8. The vertical slush machine according to claim 1, characterized in that: the scraper (2) includes an ice scraping strip (2.1) extending axially along the ice making cylinder (1), the lower end of the ice scraping strip (2.1) is provided with an ice shovel (2.2), and the ice shovel (2.2) and the ice receiving surface (a) of the slush machine are arranged at an acute angle.

9. The vertical slush machine according to claim 1, characterized in that: the inner wall of the ice cup (200) is provided with ribs (220) extending axially, used to scrape off the ice layer covering the ribs (220), and wherein the width of the ribs (220) gradually decreases along the ice discharge direction of the ice making cylinder (1), so that the outer surface of the ribs (220) gradually moves away from the central axis of the ice making cylinder (1).

10. The vertical slush machine according to claim 1, characterized in that: the ice making cylinder (1) includes an inner cylinder (1.1) and an outer cylinder (1.2) sleeved outside the inner cylinder (1.1), and a refrigeration chamber is formed between the inner cylinder (1.1) and the outer cylinder (1.2);
wherein the inner cylinder (1.1) is axially provided with annular reinforcing ribs (1.3), which divide the refrigeration chamber into an input chamber (c) and an output chamber (d); and,
the input chamber (c) and the output chamber (d) are connected through a flow passage (1.21).
